(19) United States
(12) Patent Application Publication
(10) Pub. No.: US 2014/0031080 A1
(43) Pub. Date: Jan. 30, 2014

(54) Cell Phone or mobile phone with built-in pager or paging system.

(71) Applicant: DAGANE DAAR, Potomac Falls, VA (US)

(72) Inventor: DAGANE DAAR, Potomac Falls, VA (US)

(21) Appl. No.: 13/763,705

(22) Filed: Mar. 15, 2013

Related U.S. Application Data
(60) Provisional application No. 61/676,244, filed on Jul. 26, 2012.

(51) Int. Cl. H04M 1/02

(52) U.S. Cl. CPC H04M 1/0202
USPC 455/556.1

(57) ABSTRACT

My invention is mobile communication device that combines pager or paging device and mobile or cellular phone into one device that is capable of receiving paging messages as well as cellular or mobile phone calls. This new device will enable businesses and individuals to use only one device for paging and voice communications instead of carrying one device for paging and another for mobile voice calls. In other words, instead of carrying pager and cell phone, this invention allows you to combine both and carry one device that can perform the functions of pager and cellular/mobile phone.

### CROSS-REFERENCE TO RELATED APPLICATION

This is non-provisional patent application cross-referencing to Provisional application No. 61/676,244 filed on Jul. 26, 2012.

### BACKGROUND OF INVENTION

Currently mobile or cellular phones and pagers are utilized as separate devices. Pagers are used by almost every business in United States because they provide reliable messaging service to their employees when they need them. Mobile phones are also used but their signal reception is not as reliable as the pagers. Thus people have to carry both pager and cell/mobile phone devices to receive page alerts and make calls either using their mobile phones or other paid calling services. My invention would combine the pager and mobile/cellular phone into one device which will eliminate the need to carry two devices.

### BRIEF SUMMARY OF THE INVENTION

My invention will combine paging device and cellular phones and create a device that can both receive numeric and text paging messages as well as cellular phone calls. In other words, my invention will enable people to carry one device instead of separate pagers and cellular phones.

### BRIEF DESCRIPTION OF THE DRAWING

FIG. 1 is a drawing illustrating the electronic circuitry of combined pager and cellular phone device. It includes pager and cellular antennas and receivers, the main microprocessor of the device and display screen and accessories of device.

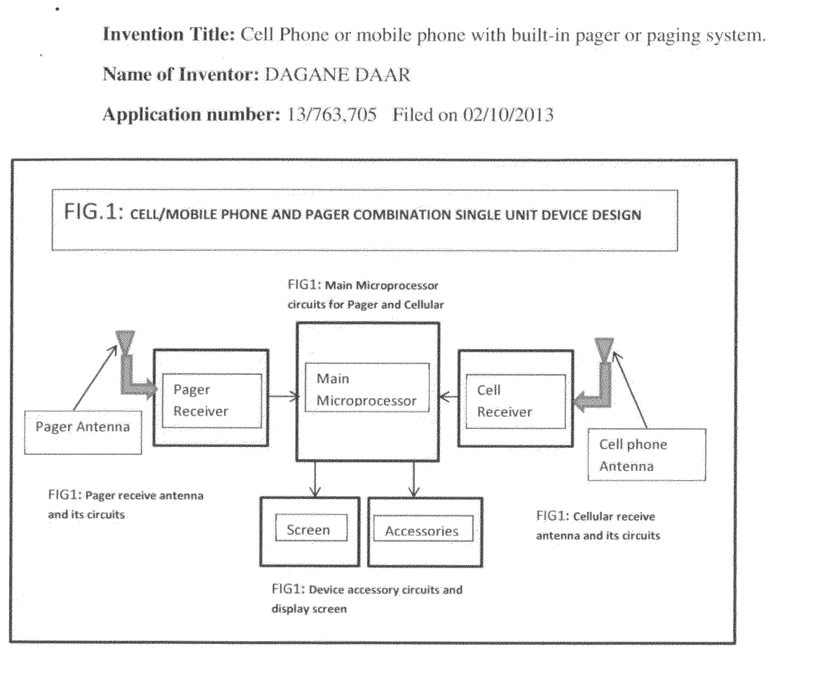

### DETAILED DESCRIPTION OF THE INVENTION

My invention will create a device that has electronics of paging system and cellular phone combined in one smart or base cellular/mobile phone unit. It will include paging system receive antenna and receiver circuitry and cellular phone reception. antenna and its receiver circuits. Both circuits are connected to main microprocessor. Alerts from pager reception antenna will be sent to mobile display as numeric or text message and calls from cellular phone antenna will be handled as normal cell phone calls.

### CLAIM

Cell or Mobile phone with built-in pager or paging system compromising: paging system and cellular or mobile phone electronics combined and housed in one portable communication device, smartphone or basic phone, capable of receiving paging signals and cell/mobile calls and displaying on same screen.

1. Cell or Mobile phone with built-in pager or paging system

2. Cell and pager device comprising of pager and cellular or mobile phone electronics combined and housed in one portable communication device, smartphone or basic phone, which is capable of receiving paging signals and cell/mobile voice calls and displaying on same screen.
